(19) United States
(12) Patent Application Publication
(10) Pub. No.: US 2026/0278761 A1
(43) Pub. Date: Sep. 17, 2026

(54) DEFECT DETECTION SYSTEM FOR MOBILE DEVICE COSMETIC INSPECTION

(71) Applicant: Apkudo, Inc., Baltimore, MD (US)

(72) Inventor: Anika PAULSEN, Hilter a.T.W. (DE)

(21) Appl. No.: 19/569,911

(22) Filed: Mar. 17, 2026

Related U.S. Application Data
(60) Provisional application No. 63/773,222, filed on Mar. 17, 2025.

(51) Int. Cl. G06T 7/00; G06T 3/40; G06T 7/70; G06V 10/26; G06V 10/764; G06V 10/774; G06V 10/82

(52) U.S. Cl. CPC G06T 7/0002; G06T 3/40; G06T 7/70; G06V 10/26; G06V 10/764; G06V 10/774; G06V 10/82; G06T 2207/10152; G06T 2207/20081; G06T 2207/20084; G06T 2207/20132

(57) ABSTRACT

A system may detect cosmetic defects on mobile device surfaces during automated processing. An imaging device may capture images of a mobile device surface under one or more lighting conditions while the mobile device is positioned within an inspection cell. A lighting component may provide the lighting conditions. A defect detection model comprising a convolutional neural network may process the captured images to generate a segmentation output identifying defect regions. The convolutional neural network may be trained on a dataset comprising real images with segmentation masks and synthetic images generated using three-dimensional rendering. The captured images may be received and processed by the defect detection model to generate the segmentation output, and a composite image of the mobile device surface indicating detected defects may be generated. The composite image may include visual indications of defect locations and associated metadata such as defect type, location, and severity characteristics.

### CROSS-REFERENCE TO RELATED APPLICATIONS

This application claims priority to U.S. Provisional Application No. 63/773,222, filed on Mar. 17, 2025, entitled Automated Mobile Device Processing System, the contents of which are hereby incorporated by reference in their entirety.

### BACKGROUND

Mobile devices, such as cell phones, have become ubiquitous tools for communication, productivity, and entertainment. Advancements in hardware and software technologies significantly enhanced the capabilities of these devices.

The lifecycle of mobile devices is often limited by rapid advancements in technology and shifting consumer preferences. Manufacturers routinely release new models, leading to frequent device upgrades by users. Older devices, while often still functional, are commonly replaced. Many of these devices are resold and reused in secondary markets, or they are repurposed for other applications.

The reuse of mobile devices is gaining importance as a practical and economic measure, allowing users and organizations to extract additional value from existing technology and reducing environmental electronic waste. Used mobile devices often find new life through resale or redistribution to users in different markets, including emerging economies. Such practices extend the usability of devices, helping bridge technological gaps and providing access to communication and digital services for a broader population.

When preparing used mobile devices for redistribution, cosmetic defects on device surfaces present challenges for inspection and grading processes. Such cosmetic defects may include scratches, dents, nicks, and debris, among other surface anomalies. Detecting and classifying these defects with consistency and accuracy can be difficult, particularly when distinguishing between similar defect types or identifying subtle surface imperfections.

### SUMMARY

At a high level, aspects described herein relate to systems and methods for detecting cosmetic defects on mobile device surfaces using artificial intelligence-based image analysis. Images of device surfaces are captured under various lighting conditions. In some cases, the image capture is performed via a cosmetic inspection cell within an automated mobile device processing system. A defect detection model comprising a convolutional neural network with an encoder-decoder architecture processes the captured images to perform pixel-level classification, identifying and categorizing surface defects such as scratches, dents, nicks, and debris. The encoder encodes multi-scale contextual information while the decoder refines segmentation results along object boundaries, enabling accurate detection of subtle surface imperfections.

The defect detection model can be trained on a dataset that includes real images with pixel-accurate segmentation masks, synthetic images generated using three-dimensional rendering techniques, or both combined. Real images may be downscaled and sliced into crops for annotation, while synthetic images may be created using displacement maps and roughness maps to simulate various defect types. This allows the defect detection model to generalize across different device models, surface finishes, and lighting conditions. The system may generate composite images indicating detected defects along with associated metadata, and may assign grades to devices based on defect characteristics including location relative to the device display.

This summary is intended to introduce a selection of concepts in a simplified form that is further described in the detailed description section of this disclosure. The summary is not intended to identify key or essential features of the claimed subject matter, nor is it intended to be used as an aid in determining the scope of the claimed subject matter. Additional objects, advantages, and novel features of the technology will be set forth in part in the description which follows, and in part will become apparent to those skilled in the art upon examination of the disclosure or learned through practice of the technology.

### BRIEF DESCRIPTION OF FIGURES

The present technology is described in detail below with reference to the attached drawing figures, wherein:

FIG. 1A is an example operating environment for a cosmetic inspection system, in accordance with an embodiment described herein;

FIG. 1B is an example cosmetic inspection cell and defect detection system, in accordance with an embodiment described herein;

FIG. 2 is an example training data pipeline for preparing training data for a defect detection model, in accordance with an embodiment described herein;

FIG. 3 is an example model training process for a defect detection model, in accordance with an embodiment described herein;

FIG. 4 is an example defect detection output showing AI-based defect analysis on a mobile device surface, in accordance with an embodiment described herein;

FIG. 5 is another example defect detection result for a mobile device, in accordance with an embodiment described herein;

FIG. 6 is an example method for detecting cosmetic defects on mobile device surfaces, in accordance with an embodiment described herein;

FIG. 7 is an example method for training a defect detection model for identifying cosmetic defects on mobile device surfaces, in accordance with an embodiment described herein;

FIG. 8 is another example method for detecting cosmetic defects on a mobile device surface, in accordance with an embodiment described herein;

FIG. 9 is an example method for detecting cosmetic defects, in accordance with an embodiment described herein;

FIG. 10 is an example method for validating a defect detection model for cosmetic inspection, in accordance with an embodiment described herein; and

FIG. 11 is an example computing device suitable for implementing the described technology, in accordance with an embodiment described herein.

### DETAILED DESCRIPTION

Traditional mobile device cosmetic inspection has historically relied on manual examination by trained personnel. Inspectors visually assess device surfaces under controlled lighting conditions to identify and characterize surface anomalies such as scratches, dents, nicks, and debris. This manual approach depends heavily on the experience and judgment of individual inspectors, who examine devices based on observed surface conditions and apply subjective criteria to determine device grades. The practice of manual inspection has remained largely unchanged, even as the volume of devices requiring inspection has increased substantially with the growth of secondary markets for mobile devices.

Existing cosmetic inspection processes face several significant challenges. Manual inspection is inherently time-consuming and labor-intensive, creating bottlenecks in device processing workflows and limiting throughput capacity. The subjective nature of human visual assessment leads to variability between inspectors, resulting in inconsistent grading outcomes where identical defects may receive different classifications depending on which inspector examines the device. Inspector fatigue over extended work periods further compounds this inconsistency, as attention to detail diminishes and detection accuracy decreases.

Traditional automated image processing techniques that have been attempted in the industry often struggle to reliably distinguish between similar defect types, such as differentiating a shallow scratch from a surface mark or debris. These conventional approaches frequently fail to detect subtle surface imperfections that are visible only under specific lighting conditions, missing defects that would be apparent to a trained human inspector under optimal viewing circumstances. Such methods typically require extensive manual tuning and parameter adjustment for different device models and surface materials, limiting their practical adaptability and requiring significant engineering effort each time a new device model enters the inspection workflow.

Additionally, the diversity of mobile device designs presents substantial difficulties for inspection systems. Modern mobile devices exhibit wide variations in surface finishes, including matte, glossy, textured, and metallic surfaces, each of which reflects light differently and presents defects with varying visual characteristics. The range of colors and materials used in device construction, from glass to aluminum to plastic composites, further complicates detection efforts. Defects may appear differently depending on the device model, surface type, and ambient conditions, making consistent and accurate detection across a wide range of devices challenging for systems that rely on fixed detection parameters or rule-based approaches. The location of defects on a device surface also affects their significance for grading purposes, as defects near the center of a display may be more visually prominent during normal device use than defects near device edges, yet conventional systems often lack the capability to account for such contextual factors. Furthermore, obtaining sufficient training data for automated systems has historically been problematic, as real-world defect samples may be limited in quantity or may not adequately represent the full spectrum of defect types and severities encountered in production environments.

The present technology addresses these challenges through an artificial intelligence-based defect detection system that employs a neural network. In aspect, the neural network can be a convolutional neural network with an encoder-decoder architecture to perform pixel-level classification of mobile device surfaces. By capturing images under various lighting conditions and processing them through a trained defect detection model, the system achieves consistent and accurate identification of surface defects including scratches, dents, nicks, and debris. The encoder component of the neural network may encode multi-scale contextual information, enabling the model to recognize defects across varying sizes and appearances, while the decoder can refine segmentation results along object boundaries to accurately delineate defect regions even when they exhibit subtle visual characteristics.

To overcome the limitations of insufficient training data, aspects of the present technology combine real images with synthetic images generated using three-dimensional rendering techniques. Real image can be downscaled and sliced into crops for annotation with pixel-accurate segmentation masks, while synthetic images can be created using displacement maps and roughness maps to simulate various defect types under controlled conditions. This combined training approach enables the defect detection model to generalize effectively across different device models, surface finishes, and lighting conditions without requiring extensive manual parameter tuning for each new device type.

The system further addresses the challenge of contextual grading by accounting for defect location relative to device features such as the display center. Defects detected near the center of a display may be weighted differently than those near device edges when assigning grades, reflecting the practical impact of defect visibility during normal device use. The system can generate composite images indicating detected defects along with associated metadata, providing reliable inspection results that reduce the subjectivity inherent in manual inspection processes.

The encoder-decoder architecture of the convolutional neural network also provides a benefit because it allows the system to capture both fine-grained details and broader contextual information simultaneously. The encoder can apply atrous spatial pyramid pooling to probe features at multiple rates and multiple effective fields-of-view, allowing the model to detect defects of varying sizes within a single processing pass. Further, the decoder can refine segmentation results by bilinearly upsampling encoder features and concatenating the upsampled features with low-level features from the encoder, producing accurate defect boundaries that accurately delineate even subtle surface imperfections.

The use of multiple lighting conditions during image capture further enhances detection capabilities. Different lighting conditions reveal different defect characteristics, with some defects becoming visible only under specific illumination angles or intensities. By capturing images under conditions such as simulated daylight, low light, diffuse light, directional light, polarized light, infrared light, or ultraviolet light, the system can detect defects that might be missed under a single lighting condition. In some implementations, lighting conditions include both external light sources and light sources integrated as part of the mobile device itself, such as the device display, providing comprehensive surface illumination, including external reflection and pass through light from a backlight of the device.

Additionally, the training methodology addresses the challenge of limited real-world defect samples by augmenting real images with synthetic images generated through three-dimensional rendering. Synthetic images created using displacement maps and roughness maps can simulate a wide variety of defect types, severities, and surface conditions, expanding the training dataset beyond what would be practically obtainable from real-world samples alone. This approach enables the defect detection model to generalize to new device models and surface types without requiring extensive retraining or parameter adjustment.

It will be realized that the methods previously described are examples that can be practiced from the description that follows, and they are provided to more easily understand the technology and recognize its benefits. Additional examples are now described with reference to the figures.

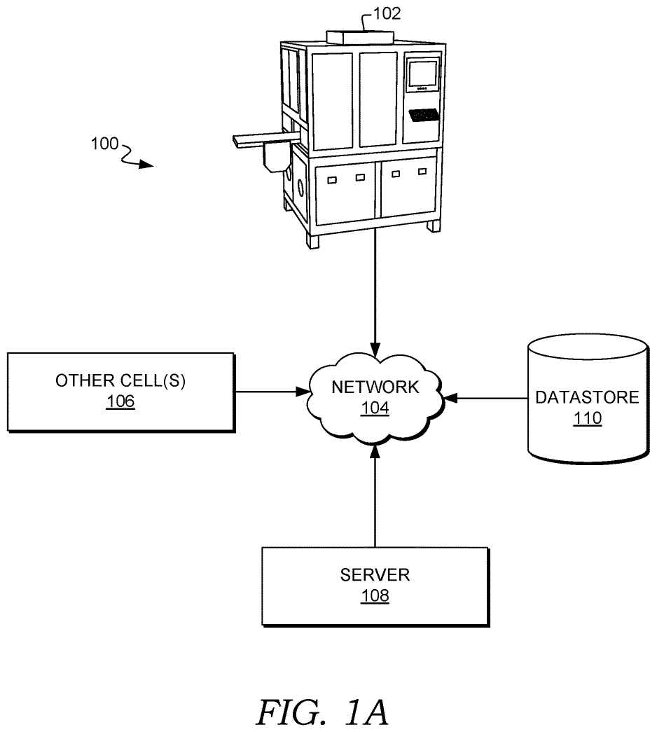

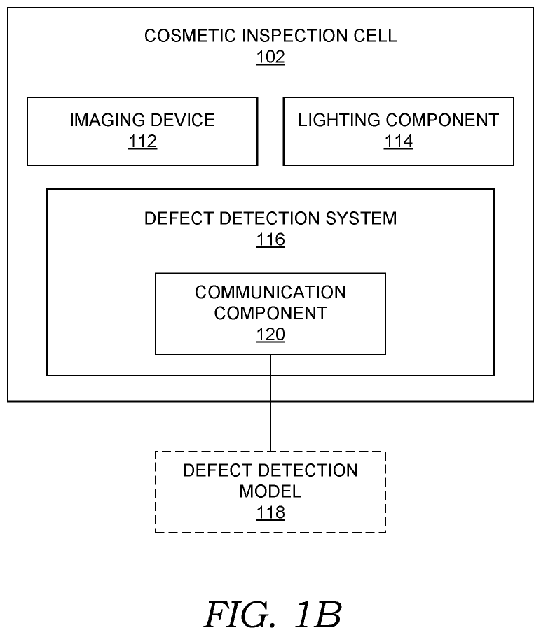

Referring now to FIG. 1A, an example operating environment 100 for a cosmetic inspection system is illustrated. The operating environment 100 includes a cosmetic inspection cell 102, other cell(s) 106, and a server 108, each connected to a network 104. The cosmetic inspection cell 102 may communicate with the network 104 to transmit inspection data, such as captured images of mobile device surfaces and defect detection results. In aspects, the cosmetic inspection cell 102 visually inspects mobile devices to identify surface defects such as scratches, dents, nicks, and debris using imaging and AI-based defect detection, as will be described in greater detail with reference to FIG. 1B.

The mobile device being inspected may be any portable electronic device, including but not limited to smartphones, tablet computers, smartwatches, portable media players, e-readers, handheld gaming devices, or other handheld computing devices. Such mobile devices typically include one or more surfaces that may be subject to cosmetic defects, including front surfaces with displays, rear surfaces with housings or back covers, and side surfaces with frames or bezels. The surfaces may be constructed from various materials including glass, metal, plastic, ceramic, or composite materials, each presenting different visual characteristics and defect appearances.

Network 104 may include one or more networks (e.g., public network or virtual private network [VPN]), as shown with network 104. Network 104 may include, without limitation, one or more local area networks (LANs), wide area networks (WANs), or any other communication network or method. Components of the operating environment 100 may be networked via wired connections, wireless connections, or combinations thereof. Wired connections may include Ethernet, fiber optic cables, or other physical communication links, while wireless connections may include Wi-Fi, cellular, Bluetooth, or other wireless communication protocols.

The other cell(s) 106 may represent additional processing or inspection cells within an automated mobile device processing system that may also connect to the network 104. The other cell(s) 106 may include cells dedicated to specific tasks such as cleaning, display inspection, camera inspection, audio inspection, data clearing, device buffing, packaging, and storage, among others. Each cell may be configured to perform one or more specific tasks on a mobile device. The cells may be arranged in a processing line through which mobile devices pass sequentially, or may be arranged in other configurations. The cosmetic inspection cell 102 and the other cell(s) 106 may be integrated into an automated mobile device processing system that streamlines the inspection, and in some cases the cleaning, repair, and grading of mobile devices.

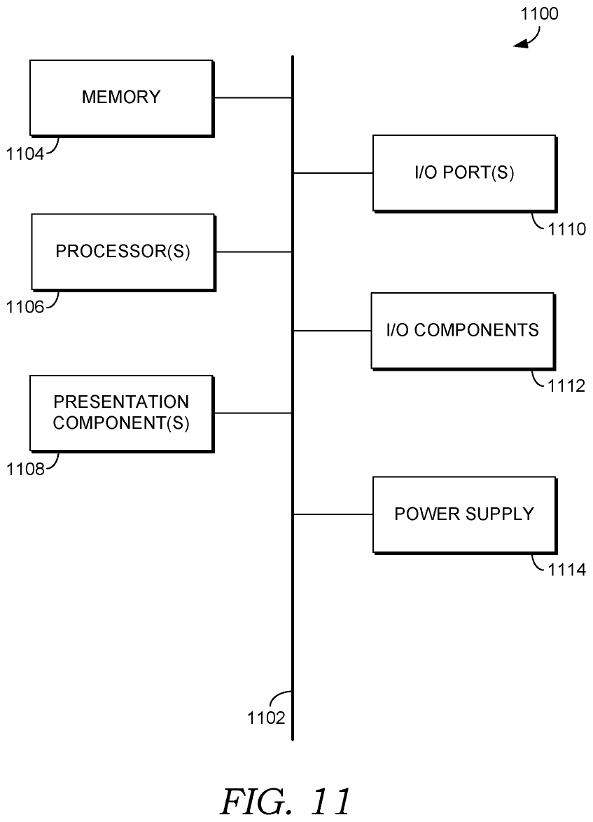

The server 108 may be a computing device, such as computing device 1100 described with reference to FIG. 11, provides processing, storage, or management capabilities. The server 108 may be communicatively coupled to a database 110 for storing inspection results, device grades, defect detection model parameters, training data, or other information relevant to the cosmetic inspection process. In some aspects, the server 108 may provide input data and instructions to the automated mobile device processing system and control operational aspects of the system, such as deploying testing profiles, calibration files, or updated model parameters to the cosmetic inspection cell 102 or the other cell(s) 106. In some aspects, the server 108 may perform functions of defect detection, such as executing the defect detection model using information, such as images, received from cosmetic inspection cell 102, as will be described in greater detail with reference to FIG. 1B.

Referring now to FIG. 1B, the cosmetic inspection cell 102 and a defect detection system 116 are illustrated in greater detail. The cosmetic inspection cell 102 may include an imaging device 112 and a lighting component 114. The imaging device 112 may capture images of a mobile device surface under one or more lighting conditions provided by the lighting component 114.

The imaging device 112 may comprise one or more cameras that capture images of the mobile device when present in the cosmetic inspection cell 102. In aspects, the imaging device 112 may include high-resolution cameras capable of capturing detailed images of device surfaces for analysis by the defect detection system 116. The imaging device 112 may be positioned to capture images of multiple sides of the mobile device, including front, back, and side surfaces, either simultaneously or sequentially as the device moves along a movement path within the cosmetic inspection cell 102.

The lighting component 114 may include a plurality of lighting elements that illuminate the surface of the mobile device. The lighting component 114 may be configured to provide varying lighting conditions as the mobile device moves through the cosmetic inspection cell 102. In aspects, the lighting component 114 may include static lighting components that are controlled at specific points in time and may be repeatable over time. For instance, a static lighting component may provide a first lighting condition at a first time and a second lighting condition at a second time, with this pattern repeated for each device passing through the cell.

The lighting conditions provided by the lighting component 114 may include simulated daylight conditions to identify surface defects like scratches and smudges, low light conditions to identify subtle dents or surface irregularities, diffuse light to reduce shadows and highlight surface texture, directional light from specified angles to create shadows and highlights that accentuate surface defects, polarized light to reduce glare and reflections on glossy surfaces, visible light in the range of 400 nm to 780 nm to provide standard illumination for general defect detection, infrared light in the range of 780 nm to 1 mm to detect heat patterns and underlying defects, and ultraviolet light in the range of 100 nm to 400 nm to highlight surface contaminants through fluorescence. Each different lighting condition may be provided for the detection of a different defect characteristic, and each lighting condition may be specific to a surface characteristic such as material, reflectiveness, color, or shape.

In some aspects, the lighting conditions may include both external light sources provided by the lighting component 114 and light sources integrated as part of the mobile device itself, such as the device display when in an on-configuration. Illuminating the surface via the display can make defects more apparent, providing an advantage over diagnostic testing that observes displays only in an off-configuration.

The communication component 120 may facilitate data transfer between the imaging device 112 and the defect detection model 118. In some aspects, the communication component 120 may transmit captured images from the imaging device 112 to the defect detection model 118 for analysis. The communication component 120 may also transmit defect detection results from the defect detection model 118 to other components or systems. In some cases, the communication component 120 may communicate with external systems via the network 104, such as the server 108 or the other cell(s) 106.

The defect detection model 118 is shown in dashed lines in FIG. 1B, indicating that the defect detection model 118 may be integrated within the cosmetic inspection cell 102 or may be executed at a server, such as the server 108, in remote communication with the cosmetic inspection cell 102 via the network 104. In some aspects, the communication component 120 may transmit captured images to the server 108 for processing by the defect detection model 118.

The defect detection system 116 is illustrated and described with reference to the cosmetic inspection cell 102. However, it is noted that the defect detection system 116 may be part of another component, such as another cell within the automated mobile device processing system. In some aspects, defect detection system 116 may be a stand-alone system that captures or accesses image data for defect detection of mobile devices.

In some aspects, the defect detection model 118 may comprise a convolutional neural network with an encoder-decoder architecture configured to perform pixel-level classification of the captured images. The encoder may encode multi-scale contextual information, while the decoder may refine segmentation results along object boundaries. The defect detection model 118 may process the captured images to identify and categorize surface defects such as scratches, dents, nicks, and debris. In some aspects, the defect detection model 118 may generate segmentation outputs and composite images indicating detected defects along with associated metadata.

The defect detection model 118 may comprise a machine learning model. The model can be trained to analyze images of mobile device surfaces and identify defect regions. In some aspects, the defect detection model 118 may comprise a neural network. Neural networks may be suited for image analysis tasks, as they can learn patterns and features from input images to identify defects on mobile device surfaces. In some aspects, the neural network may be a convolutional neural network (CNN). Convolutional neural networks are often suited for image analysis tasks, as they can learn spatial hierarchies of features from input images. The defect detection model 118 may perform pixel-level classification of the captured images to identify and locate cosmetic defects on the mobile device surface.

In some aspects, the convolutional neural network may have an encoder-decoder architecture. The encoder may encode multi-scale contextual information from the captured images by progressively extracting features at different levels of abstraction. The encoder may apply atrous convolution, also known as dilated convolution, at multiple scales to capture features at different resolutions without reducing spatial resolution. Atrous spatial pyramid pooling may be employed to probe features at multiple rates and multiple effective fields-of-view, enabling the encoder to recognize defects of varying sizes within a single processing pass. The decoder may refine segmentation results along object boundaries by upsampling encoder features, such as by bilinearly upsampling by a factor of at least four, and concatenating the upsampled features with low-level features from earlier stages of the encoder. This combination of high-level semantic information with fine-grained spatial details enables the decoder to produce accurate defect boundaries that delineate surface imperfections. The resulting segmentation output may classify each pixel into defect categories or distinguish between defective and non-defective regions with high spatial accuracy.

As examples, the defect detection model 118 may comprise architectures such as DeepLabV3+, U-Net, or other segmentation architectures that can perform pixel-level classification. In some aspects, the defect detection model 118 may use an encoder such as a RegNet encoder, a ResNet encoder, or another feature extraction backbone. The defect detection model 118 may perform binary segmentation to distinguish between defective and non-defective regions, or may perform multi-class segmentation to classify pixels into defect categories such as scratch, dent, nick, and debris.

The defect detection model 118 may process the captured images to identify and categorize surface defects such as scratches, dents, nicks, and debris. In some aspects, the defect detection model 118 may generate segmentation outputs identifying defect regions, where each defect region corresponds to a contiguous area of pixels classified as belonging to a particular defect category. The defect detection model 118 may generate probability heatmaps indicating confidence levels for detected defects at each pixel location, where the heatmap provides a visual representation of the model's certainty regarding the presence of defects across the device surface. Higher probability values in the heatmap may indicate greater confidence that a defect exists at a particular location, while lower probability values may indicate areas where the model is less certain or where no defect is detected. Additionally, the defect detection model 118 may generate composite images indicating detected defects, where the composite images overlay visual indications of defect locations onto the original captured images or device image representations to visually represent where defects have been identified on the mobile device surface. The visual indications may include colored highlights, bounding regions, or other graphical markers that distinguish defect regions from non-defective areas. Associated metadata, such as defect location, defect type, reflectivity, contrast ratio, depth of scratch, or other characteristics, may be generated along with the outputs to provide additional context for each detected defect.

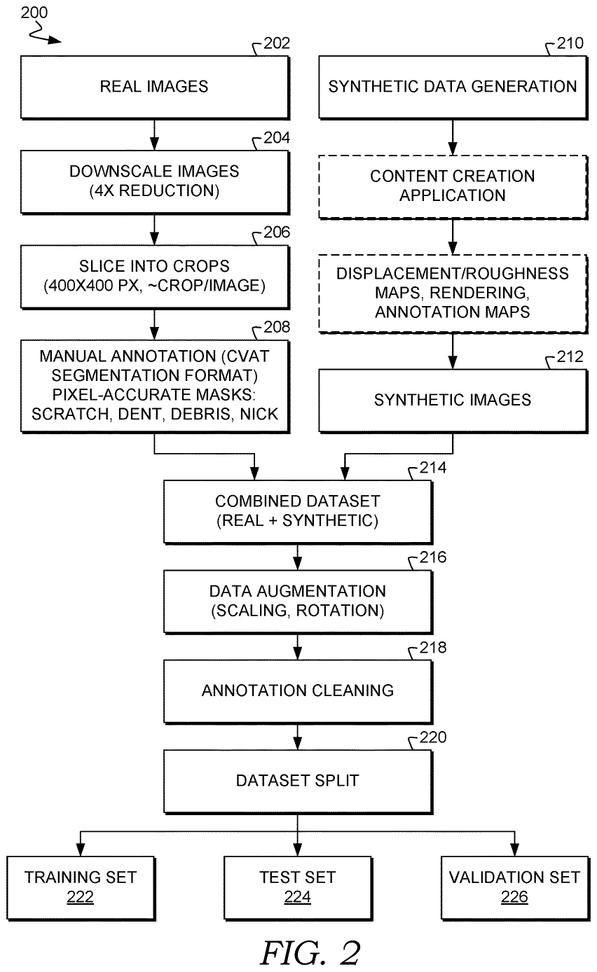

Referring now to FIG. 2, an example training data pipeline 200 for preparing training data for the defect detection model 118 is illustrated. The training data pipeline 200 may combine real images with synthetic images to create a comprehensive dataset for training the defect detection model 118. The combination of real and synthetic data may enable the defect detection model 118 to generalize across different device models, surface finishes, and lighting conditions.

While FIG. 2 illustrates the training data pipeline 200. The flow diagram illustrated in FIG. 2 provides an example for generating training data that includes both real images and synthetic images. The use of both real and synthetic images in the training data pipeline 200 is one example approach, and other configurations of training data may be employed.

In this example, FIG. 2 illustrates a first path for generating real images that can be used for training and a second path for generating synthetic data images that can be used for training. FIG. 2 further illustrates the combination of both the real images and synthetic images into a combined dataset to be used as a training set, test set, and validation set. The first path may process real images captured by the imaging device 112 or similar imaging equipment. At step 202, real images of mobile device surfaces may be captured under one or more lighting conditions. The lighting conditions may include simulated daylight to reveal scratches and smudges, low light conditions to identify subtle dents or surface irregularities, diffuse light to reduce shadows and highlight surface texture, directional light from specified angles to create shadows and highlights that accentuate surface defects, polarized light to reduce glare and reflections on glossy surfaces, infrared light to detect heat patterns and underlying defects, and ultraviolet light to highlight surface contaminants through fluorescence. The real images may capture multiple surfaces of mobile devices, including front surfaces with displays, rear surfaces with housings or back covers, and side surfaces with frames or bezels. The surfaces may be constructed from various materials including glass, metal, plastic, ceramic, or composite materials, each presenting different visual characteristics and defect appearances. The real images may encompass a variety of surface finishes, including matte, glossy, textured, and metallic surfaces, each of which reflects light differently and presents defects with varying visual characteristics. The real images may include images from a diverse range of mobile device types, including smartphones, tablet computers, smartwatches, portable media players, e-readers, handheld gaming devices, and other handheld computing devices. The real images may further include devices from different manufacturers, different model generations, and devices exhibiting a range of colors and materials used in device construction, from glass to aluminum to plastic composites. This diversity in the captured real images enables the defect detection model to generalize across different device models, surface finishes, and lighting conditions.

At step 204, the real images may be downscaled by a scaling factor to reduce the image size. The downscaling may be done in a manner that maintains sufficient detail for defect detection. Generally, downscaling involves reducing the resolution of the captured images. This may be done by a predetermined ratio, which decreases the number of pixels in each image. In some aspects, the scaling factor may be four or more, meaning that the original image dimensions are reduced by a factor of at least four in each direction. The downscaling can reduce computational requirements during training while preserving the visibility of defects that are relevant for grading purposes. By reducing the image resolution, the training process requires less memory and processing power, enabling more efficient model training without sacrificing the ability to detect defects of practical significance. The scaling factor may be selected based on the resolution of the original captured images and the minimum defect size that needs to be detected for grading purposes.

At step 206, the downscaled real images may be sliced into image crops of a predetermined size. In some aspects, the crops may have a size of at least 400 by 400 pixels, though other crop sizes may be employed depending on the resolution requirements and computational constraints of the system. The slicing may be performed with an overlap percentage between adjacent crops. For example, the overlap percentage may be up to 10%, or another suitable percentage. The overlap percentage may help so that defects near crop boundaries are adequately represented in the training data, ensuring that defects spanning multiple crops are captured in their entirety in at least one crop. Processing smaller image portions (the crops) rather than full-resolution device images may reduce computational requirements, such as memory and processing power, during training of the neural network. Additionally, slicing may effectively expand the training dataset by generating multiple training samples from each real image. For example, each real image may be sliced into approximately 32 crops, thereby increasing the number of available training samples from a limited set of real images. In some cases, working with smaller image portions may also facilitate more precise pixel-accurate annotation, as annotation may more readily identify and mark defects within a smaller, more manageable image area.

At step 208, annotation may be performed on the image crops using pixel-accurate segmentation masks. In some aspects, annotation may be performed automatically by identifying defects using image processing algorithms or preliminary machine learning models that detect candidate defect regions. In some aspects, annotation may be performed by receiving user inputs identifying defect locations and boundaries, such as through a manual annotation interface where human annotators mark defect regions on the image crops. In some aspects, annotation may be performed by receiving images of the crops with pre-existing annotations from external sources or previously annotated datasets. The annotation process may involve identifying and marking defects larger than a threshold size, such as 5 by 5 pixels, or defects having contrast above a threshold contrast level. The segmentation masks may provide ground truth labels for training the defect detection model 118 to recognize and classify different defect types.

As noted, some training aspects also employ the use of synthetic data. A second path is illustrated in FIG. 2 that provides an example of generating synthetic images to augment the real image data. At step 210, synthetic data can be generated using a three-dimensional rendering application with procedural generation algorithms for creating displacement maps and roughness maps that simulate surface defects. In some implementations, generating the synthetic images may be performed responsive to receiving inputs specifying defect parameters, surface characteristics, or rendering conditions. In some implementations, the techniques described herein may be performed using a digital content creation (DCC) application that provides tools for authoring and editing three-dimensional (3D) scenes, including geometric models, materials, lighting, cameras, and animation data. As an example, the DCC application may comprise Blender or other suitable rendering software capable of generating photorealistic images with controlled surface properties, such as applications that support physically-based rendering techniques. The procedural generation algorithms may include noise-based algorithms, fractal algorithms, or parametric surface deformation algorithms that programmatically define defect characteristics. The displacement maps define the geometric deformation of the surface to simulate defects such as dents and nicks, while the roughness maps define variations in surface reflectivity to simulate defects such as scratches. The rendering process produces synthetic images with corresponding annotation maps that provide pixel-accurate labels for the simulated defects. At step 212, the synthetic images are output. The synthetic images may be output with corresponding annotation maps. The annotation maps may provide pixel-accurate labels identifying the locations and classifications of the simulated defects within each synthetic image.

At step 214, the annotated image crops from the first path and the synthetic images from the second path are combined into a combined dataset. The combination of real and synthetic data addresses the challenge of limited real-world defect samples by expanding the training dataset beyond what would be practically obtainable from real-world samples alone. At step 216, data augmentation may be applied to the combined dataset, including transformations such as rotations and scaling. This may increase the diversity of training samples and improve the generalization capability of the defect detection model 118.

At step 218, annotation cleaning may be performed using image processing techniques. The cleaning process may address inaccuracies in the annotations, particularly for large annotations that may span multiple small anomalies. Annotation cleaning may produce pixel-accurate annotations that help accurately delineate defect boundaries At step 220, the cleaned and augmented dataset is split into a training set 222, a test set 224, and a validation set 226. The training set 222 can be used to train the defect detection model 118, while the test set 224 may be used to evaluate model performance during development. The validation set 226 may be used to validate the trained model against known samples with annotated defects.

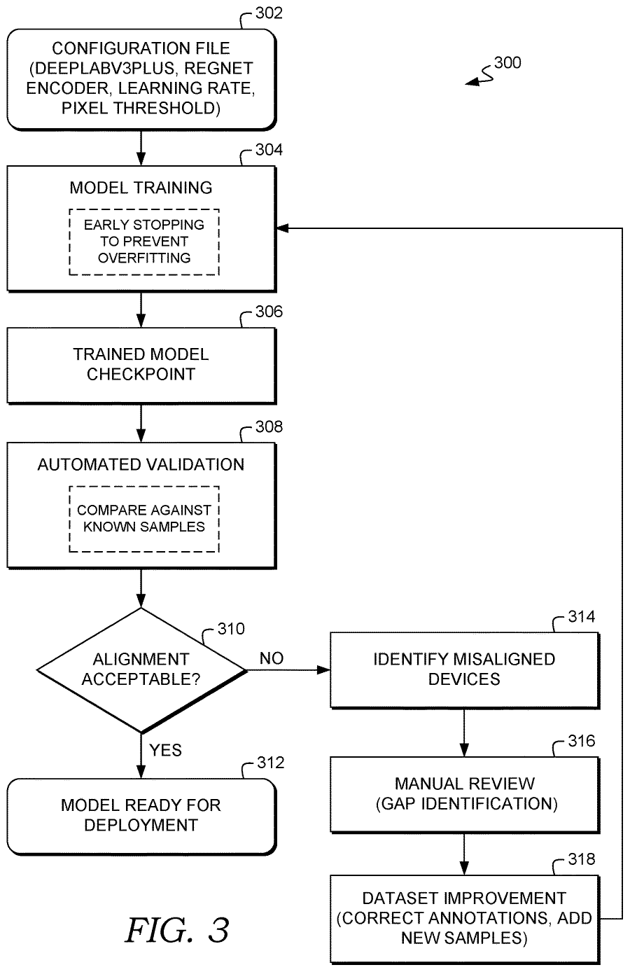

Referring now to FIG. 3, a model training and validation process 300 for the defect detection model 118 is illustrated. The process 300 begins at step 302 where a configuration file specifying model architecture parameters is provided. The configuration file may define the model architecture, along with training hyperparameters including the number of segmentation classes, pixel threshold, learning rate, and weight decay settings. In some aspects, the configuration may specify segmenting pixels into a number of classes ranging from four to ten classes, such as six classes, with a pixel threshold ranging from about 0.5 to about 0.95, such as 0.75, a learning rate ranging from about 0.00001 to about 0.001, such as 0.0001, and a weight decay ranging from about zero to about 0.01, such as no weight decay.

At step 304, model training is performed using the training set 222. Early stopping may be employed to prevent overfitting, where training is halted when validation performance ceases to improve over a predetermined number of consecutive epochs. During training, the model's performance on a held-out validation set may be monitored after each epoch, and if the validation loss fails to decrease or the validation accuracy fails to increase for a specified patience period, training may be terminated to prevent the model from memorizing training data rather than learning generalizable patterns.

During training at step 304, a loss function may be used to measure the difference between the predicted segmentation outputs of the defect detection model 118 and the ground truth annotations provided by the segmentation masks. The loss function may quantify how well the model's predictions match the expected defect classifications at each pixel. In some aspects, the loss function may comprise a cross-entropy loss, a dice loss, a focal loss, or combinations thereof. The model parameters may be updated during training to minimize the loss function, thereby improving the accuracy of the defect detection model 118 over successive training iterations.

An optimizer may be used to update the model parameters based on the computed loss. In some aspects, the optimizer may comprise a gradient-based optimizer such as Adam, stochastic gradient descent (SGD), or another suitable optimization algorithm. The optimizer may adjust the model parameters in a direction that reduces the loss, using a learning rate that controls the magnitude of parameter updates at each step.

Training may be performed over multiple epochs, where each epoch may comprise processing the training data in batches of a predetermined batch size. A batch may comprise a subset of the training samples that are processed together before the model parameters are updated. The batch size may be selected based on available computational resources, such as memory capacity. In some aspects, after each epoch, the model's performance on the validation set 226 may be evaluated to monitor training progress and determine whether early stopping criteria have been met.

In some aspects, the encoder of the convolutional neural network may be initialized with pre-trained weights from a model previously trained on a general image classification task, such as image classification on a large-scale dataset. The pre-trained weights may provide the encoder with learned feature representations that can be fine-tuned on the defect detection dataset, potentially reducing the amount of training data needed to achieve acceptable performance. This approach, sometimes referred to as transfer learning, may be beneficial when the available defect detection training data is limited.

At step 306, a trained model checkpoint may be produced. The trained model checkpoint may represent the learned parameters of the defect detection model 118 at a point during training. At the trained model checkpoint, the learned parameters may be stored for subsequent use in defect detection, further training, or deployment to the cosmetic inspection cell 102 or the server 108.

At step 308, automated validation can be performed against the validation set 226. In performing the validation, alignment between model predictions and the annotated defects may be calculated. The validation may calculate validation metrics indicating how well the model predictions align with the ground truth annotations.

The validation metrics used to calculate alignment may include accuracy, intersection over union (IoU), precision, recall, F1 score, or combinations thereof. In some aspects, these metrics may provide different perspectives on model performance, such as the ability to correctly identify defect regions, the ability to avoid false detections, and the overall overlap between predicted and ground truth defect boundaries.

At step 310, a determination may be made whether the alignment between model predictions and annotated defects satisfies a threshold. The threshold may be a minimum accuracy percentage, a minimum intersection over union (IoU) score, or a combination of metrics that must each satisfy respective thresholds. In some aspects, the threshold may be configurable and may vary depending on the intended use case or customer-specific grading requirements. For instance, stricter inspection requirements, such as where even minor defects affect the assigned grade, may require a higher alignment threshold than use cases where only significant defects are relevant to grading.

If the alignment satisfies the threshold, the process may proceed to step 312 where the model may be ready for deployment. Deployment may include storing the trained model checkpoint for use in processing incoming mobile devices, deploying the model to the cosmetic inspection cell 102, the server 108, or both, or making the model available for inference via the communication component 120. In some aspects, the trained model checkpoint may be packaged with the configuration file from step 302 for deployment. In some aspects, the deployed model may replace a previously deployed model, or may be deployed alongside an existing model for comparison. In some cases, model updates may be deployed without interrupting the processing line of mobile devices.

If the alignment does not satisfy the threshold, the process may proceed to step 314 to identify misaligned devices from the validation set. The automated validation may flag devices where the model's predictions diverge from the ground truth annotations by more than a specified margin. In some aspects, the identification may categorize misalignments by defect type, device region, or surface material to help focus the subsequent review at step 316. For example, the identification may reveal that a disproportionate number of misalignments occur for a particular defect type, such as nicks, or on a particular surface area of the device, such as near edges or around camera modules.

At step 316, review and gap identification may be performed on the misaligned devices to identify gaps in model performance. The receiving the model's predictions compared against the ground truth annotations for the misaligned devices to identify patterns in the misalignment, such as particular defect types, device regions, or surface materials where the model underperforms. For example, the review may identify differences between similar defect types, such as distinguishing between nicks and dents, or between debris and scratches. In some cases, defects in shadowed areas may be misclassified, or defects on surfaces with different reflective properties, such as a glossy surface versus a matte surrounding area, may appear more or less severe than they actually are, leading to inaccurate classifications.

At step 318, dataset improvement may be performed based on the identified gaps. The improvement may include receiving corrected annotations to those that were inaccurate or adding new annotated samples to address underrepresented defect types or device configurations. In some cases, the improvement may include rebalancing the dataset to address underrepresented defect categories, or adding samples from specific device regions or surface types where the model showed weakness during validation. From step 318, the process may loop back to step 304 for retraining with the improved dataset. This iterative process of training, validation, gap identification, and dataset improvement may continue until the model achieves acceptable alignment with the ground truth annotations.

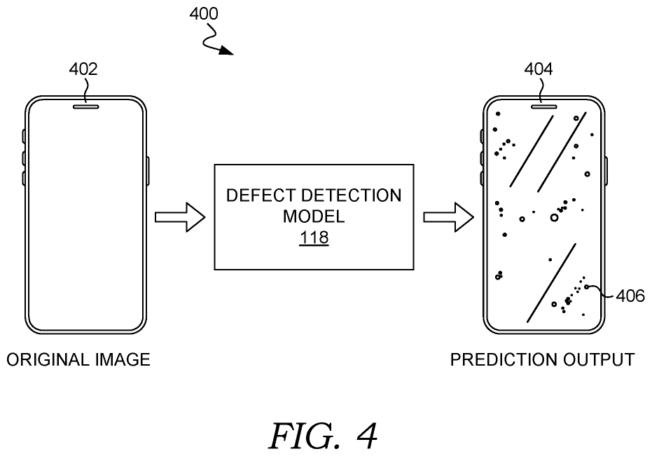

Referring now to FIG. 4, a defect detection output 400 illustrating an inference representation using the defect detection model 118 is shown. The defect detection output 400 demonstrates the application of the trained defect detection model 118 to analyze a mobile device surface and identify cosmetic defects.

An original image 402 represents the captured image of the mobile device surface that is input to the defect detection model 118. The original image 402 may be captured by the imaging device 112 under one or more lighting conditions provided by the lighting component 114. As shown, the original image 402 depicts the mobile device surface with subtle, barely visible defects that may be difficult to identify through manual inspection or conventional image processing techniques.

The defect detection model 118 processes the original image 402 to perform pixel-level classification and identify defect regions on the mobile device surface. A prediction output 404 shows the results of this analysis, where the same device surface is displayed with detected anomalies highlighted. In the prediction output 404, the defect detection model 118 has identified and marked various surface defects including scratches, dents, nicks, and debris using visual indications such as colored highlights. An example defect 406 is illustrated. The prediction output 404 demonstrates the ability of the defect detection model 118 to detect defects that may not be readily apparent in the original image 402, providing a clear visualization of the identified defect regions.

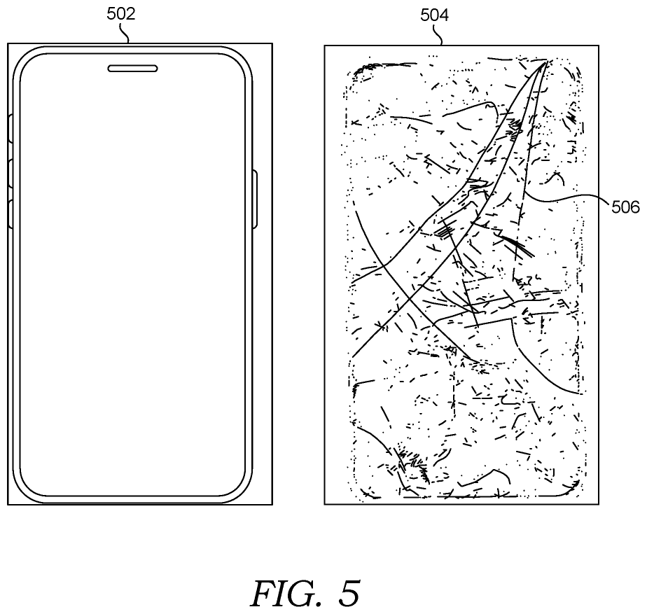

Referring now to FIG. 5, another example defect detection result for a mobile device is illustrated. FIG. 5 depicts images from an example defect detection model that has been reduced to practice. An original image 502 shows the captured image of the mobile device surface as input to the defect detection model 118. The original image 502 may be captured under one or more lighting conditions to reveal surface characteristics and potential defects. Similar to the original image 402 described with reference to FIG. 4, the original image 502 may contain defects that are subtle or difficult to discern through visual inspection alone.

A prediction output 504 shows the segmentation results generated by the defect detection model 118 after processing the original image 502. The prediction output 504 displays example defect region 506 identified on the device surface through pixel-level classification. The defect region 506 may correspond to various defect categories such as scratches, dents, nicks, or debris, with each defect region delineated based on the semantic segmentation performed by the convolutional neural network.

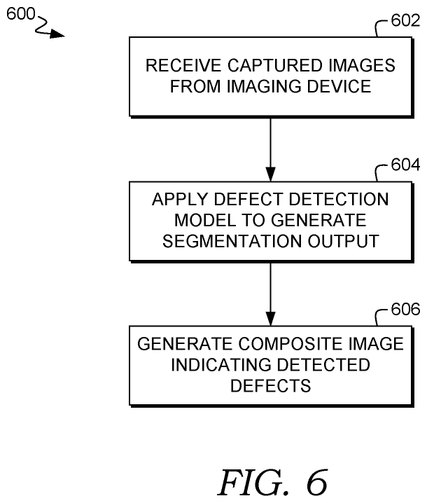

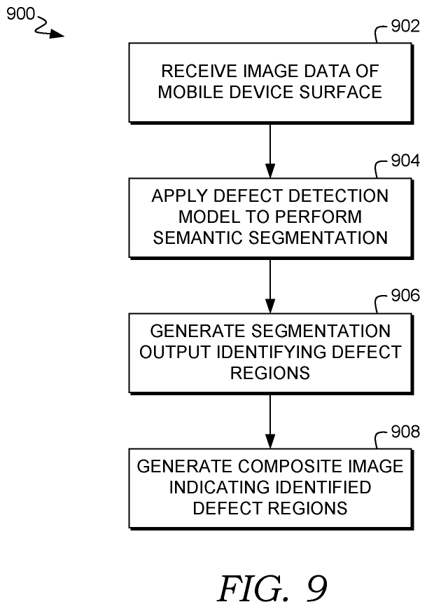

With reference now to FIGS. 6-10, block diagrams are provided respectively illustrating methods 600, 700, 800, 900, and 1000 that relate to detecting cosmetic defects on mobile device surfaces, training a defect detection model, and validating a defect detection model for cosmetic inspection. Each block of the methods may comprise a computing process performed using any combination of hardware, firmware, or software. For instance, the methods can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities.

Referring now to FIG. 6, a block diagram of an example method 600 for detecting cosmetic defects on mobile device surfaces is illustrated. The example method 600 may be performed by a system comprising an imaging device, a lighting component, a defect detection model, and a processor, such as the imaging device 112, the lighting component 114, the defect detection model 118, and a processor of the defect detection system 116 described with reference to FIG. 1B.

At block 602, captured images are received from the imaging device. The imaging device may be configured to capture images of a mobile device surface under one or more lighting conditions while the mobile device is positioned within an inspection cell that is part of an automated mobile device processing system, such as the cosmetic inspection cell 102 described with reference to FIGS. 1A and 1B. The lighting component may be configured to provide the one or more lighting conditions. In aspects, each lighting condition of the one or more lighting conditions may be specific to a surface characteristic of the mobile device surface. For example, the one or more lighting conditions may comprise at least two of simulated daylight, low light, diffuse light, directional light, polarized light, infrared light, or ultraviolet light. In some aspects, the one or more lighting conditions may comprise a first lighting condition provided by a light source external to the mobile device and a second lighting condition provided by a light source integrated as part of the mobile device.

At block 604, the defect detection model may be applied to the captured images to generate a segmentation output identifying defect regions. The defect detection model may comprise a convolutional neural network trained on a dataset comprising real images with segmentation masks and synthetic images generated using three-dimensional rendering. In aspects, the convolutional neural network may have an encoder-decoder architecture, the encoder configured to encode multi-scale contextual information, and the decoder configured to refine segmentation results along object boundaries. The decoder may be configured to refine segmentation results by bilinearly upsampling encoder features and concatenating the upsampled features with low-level features from the encoder. The dataset may comprise real images that are downscaled and sliced into crops, where the crops may have a size of at least 400 by 400 pixels. The synthetic images may be generated using displacement maps and roughness maps. The segmentation masks may be pixel-accurate and generated using manual annotation of defects larger than a threshold size, such as at least 5 by 5 pixels. In some aspects, the segmentation output may classify pixels of the captured images into defect categories comprising at least scratch, dent, nick, and debris.

At block 606, a composite image of the mobile device surface is generated and indicates detected defects. The composite image may comprise visual indications selectable to view metadata associated with the detected defects. The metadata associated with the detected defects may comprise at least one of location, reflectivity, contrast ratio, depth of scratch, or surface type. In aspects, the processor may be further configured to assign a grade to the mobile device based on the detected defects, wherein the grade is determined at least in part by a location of a detected defect relative to a center of a display of the mobile device.

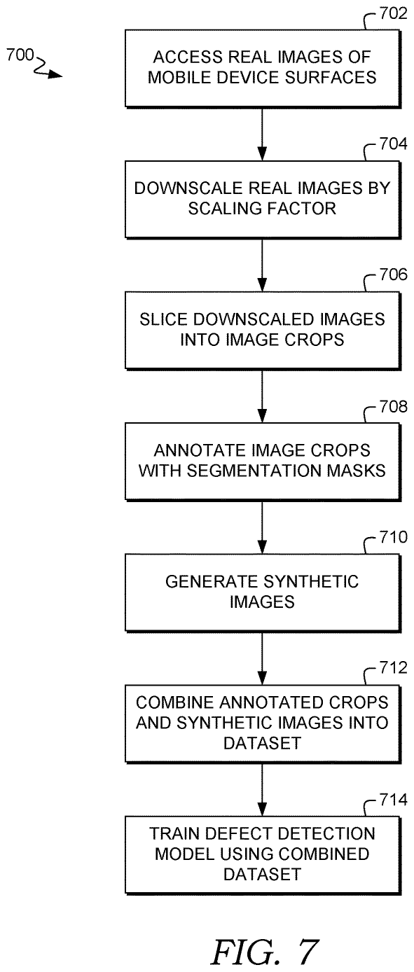

Referring now to FIG. 7, a block diagram of an example method 700 for training a defect detection model for identifying cosmetic defects on mobile device surfaces is illustrated. At block 702, a plurality of real images of mobile device surfaces captured by an imaging device under one or more lighting conditions is accessed. The real images may be captured by the imaging device 112 within the cosmetic inspection cell 102 or by similar imaging equipment configured to capture high-resolution images of mobile device surfaces. The one or more lighting conditions may include simulated daylight to reveal scratches and smudges, low light conditions to identify subtle dents or surface irregularities, diffuse light to reduce shadows and highlight surface texture, directional light from specified angles to create shadows and highlights that accentuate surface defects, polarized light to reduce glare and reflections on glossy surfaces, infrared light to detect heat patterns and underlying defects, and ultraviolet light to highlight surface contaminants through fluorescence. The real images may capture multiple surfaces of mobile devices, including front surfaces with displays, rear surfaces with housings or back covers, and side surfaces with frames or bezels. The real images may encompass a variety of surface finishes, including matte, glossy, textured, and metallic surfaces, and may include images from a diverse range of mobile device types, manufacturers, and model generations to enable the defect detection model to generalize across different device configurations.

At block 704, the plurality of real images are downscaled by a scaling factor. The downscaling reduces the resolution of the captured images by a predetermined ratio, decreasing the number of pixels in each image while maintaining sufficient detail for defect detection. In some aspects, the scaling factor may be four or more, meaning that the original image dimensions are reduced by a factor of at least four in each direction. The scaling factor may be selected based on the resolution of the original captured images and the minimum defect size that needs to be detected for grading purposes.

At block 706, the downscaled real images are sliced into image crops of a predetermined size. In some aspects, the crops may have a size of at least 400 by 400 pixels, though other crop sizes may be employed depending on the resolution requirements and computational constraints of the system. The slicing may be performed with an overlap percentage between adjacent crops, such as up to 10%, to help so that defects near crop boundaries are adequately represented in the training data and that defects spanning multiple crops are captured in their entirety in at least one crop.

At block 708, the image crops are annotated with segmentation masks identifying defect regions. The annotation process may involve identifying and marking defects larger than a threshold size, such as 5 by 5 pixels, or defects having contrast above a threshold contrast level. In some aspects, annotation may be performed automatically by identifying defects using image processing algorithms or preliminary machine learning models that detect candidate defect regions. In some aspects, annotation may be performed by receiving user inputs identifying defect locations and boundaries. In some aspects, annotation may be performed by receiving images of the crops with pre-existing annotations from external sources or previously annotated datasets. The segmentation masks provide pixel-accurate ground truth labels for training the defect detection model 118 to recognize and classify different defect types, including scratches, dents, nicks, and debris.

At block 710, synthetic images are generated using a three-dimensional rendering application, the synthetic images comprising simulated defects with corresponding annotation maps. The synthetic image generation may employ procedural generation algorithms for creating displacement maps and roughness maps that simulate surface defects. The displacement maps may define the geometric deformation of the surface to simulate defects such as dents and nicks, while the roughness maps define variations in surface reflectivity to simulate defects such as scratches. The rendering process produces synthetic images with corresponding annotation maps that provide pixel-accurate labels for the simulated defects, enabling the generation of a wide variety of defect types, severities, and surface conditions that expand the training dataset.

At block 712, the annotated image crops and the synthetic images are combined into a combined dataset. The combined dataset may undergo data augmentation, including transformations such as rotations and scaling, to increase the diversity of training samples and improve the generalization capability of the defect detection model 118. Annotation cleaning may also be performed using image processing techniques to address inaccuracies in the annotations, particularly for large annotations that may span multiple small anomalies, producing pixel-accurate annotations that accurately delineate defect boundaries. The combined dataset may be split into a training set, a test set, and a validation set for use in model training and evaluation.

At block 714, the defect detection model is trained using the combined dataset, wherein the defect detection model comprises a convolutional neural network with an encoder-decoder architecture configured to perform semantic segmentation of defects. The encoder may encode multi-scale contextual information from the training images by progressively extracting features at different levels of abstraction, and may apply atrous spatial pyramid pooling to probe features at multiple rates and multiple effective fields-of-view, enabling the model to recognize defects of varying sizes within a single processing pass. The decoder may refine segmentation results along object boundaries by upsampling encoder features and concatenating the upsampled features with low-level features from earlier stages of the encoder, producing accurate defect boundaries that delineate surface imperfections.

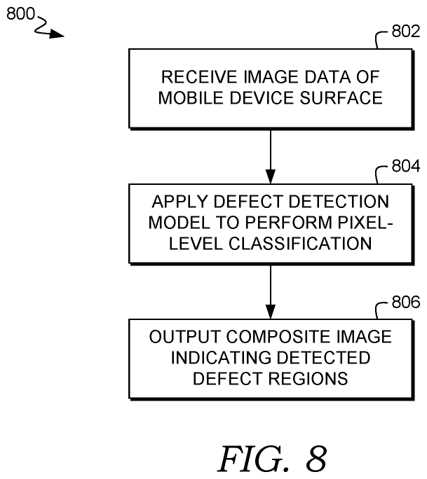

Referring now to FIG. 8, a block diagram of an example method 800 for detecting cosmetic defects on a mobile device surface is illustrated. At block 802, image data of a mobile device surface captured under one or more lighting conditions is received. The image data may be captured by the imaging device 112 under lighting conditions provided by the lighting component 114, as described with reference to FIG. 1B. In aspects, the one or more lighting conditions may comprise at least two of simulated daylight, low light, diffuse light, directional light, polarized light, infrared light, or ultraviolet light. In some aspects, each lighting condition of the one or more lighting conditions may correspond to detection of a different defect characteristic. For example, the one or more lighting conditions may comprise a first lighting condition provided by a light source external to the mobile device and a second lighting condition provided by a light source integrated as part of the mobile device, such as the device display.

At block 804, a defect detection model is applied to the image data. The defect detection model may comprise a trained convolutional neural network having an encoder that encodes multi-scale contextual information and a decoder that refines segmentation results along object boundaries. The defect detection model performs pixel-level classification to identify defect regions. An example defect detection model is described by the defect detection model 118 of FIG. 1B. In some aspects, the defect detection model may be trained on a dataset comprising real images with pixel-accurate segmentation masks and synthetic images generated using three-dimensional rendering with displacement maps and roughness maps.

At block 806, a composite image of the mobile device surface indicating detected defect regions with visual indications of defect locations identified by the defect detection model is output. The composite image may be generated by the defect detection system 116 described with reference to FIG. 1B. In aspects, the composite image may be an image of the mobile device or an image representative of the mobile device and indicate the detected defects using visual indications within the composite image. The visual indications within the composite image indicating the detected defects may be selectable to view metadata associated with the detected defects. The metadata may include one or more of defect location, reflectivity, contrast ratio, depth of scratch, or surface type where the defect is located. In some aspects, the detected defects may comprise a scratch pattern, and the composite image may visually indicate the scratch pattern along with associated metadata.

In aspects, the example method 800 may further comprise assigning a grade to the mobile device based on the detected defects. The grade may be determined at least in part by a location of a detected defect relative to a center of a display of the mobile device. The grade may also be based on the number of scratches, the depth of scratches, and other physical defects identified by the defect detection model. To provide one example grading scale, a Grade A device might be in excellent condition with minimal signs of use, no significant scratches or dents, or all functions working perfectly. A Grade B device might show moderate signs of use, such as minor scratches around the edges, or no major functional issues. A Grade C device might have noticeable scratches, including some more relatively central on the display, or minor functional issues, but still be operational. A Grade D device might have significant physical damage, such as deep scratches or dents, or functional issues that affect usability. In some aspects, the grade may be at least partially based on a generative AI output, where a generative model is prompted with the condition of the device and returns a grade based on consumer expectations for the condition of the device. Other grading scales may be used, and may be indicated by the defect detection model based on its training.

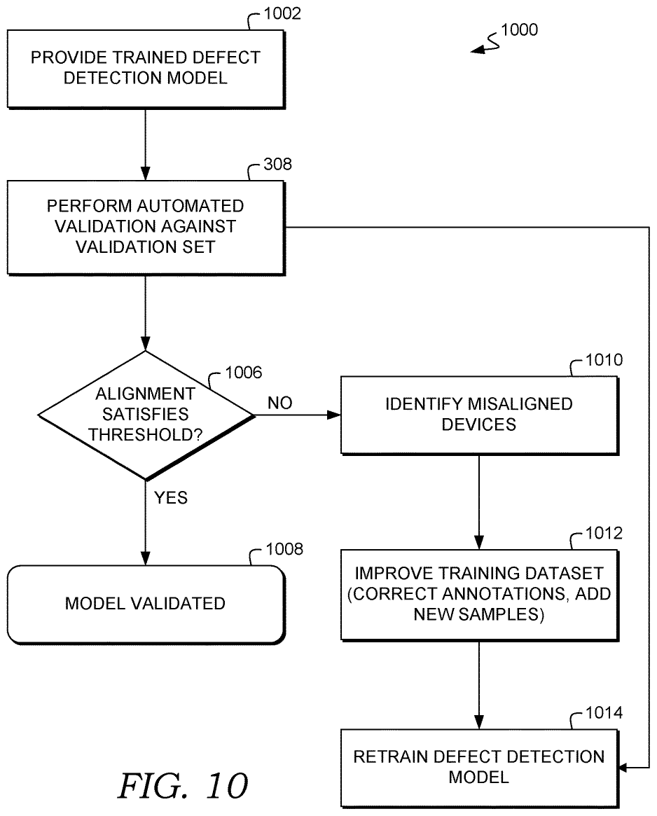

Referring now to FIG. 10, a block diagram of an example method 1000 for validating a defect detection model for cosmetic inspection of mobile devices is illustrated. At block 1002, a trained defect detection model comprising a convolutional neural network with an encoder-decoder architecture configured to perform semantic segmentation of defect categories on mobile device surfaces is provided. An example trained defect detection model is described by the defect detection model 118 of FIG. 1B. The encoder-decoder architecture may be configured such that the encoder encodes multi-scale contextual information while the decoder refines segmentation results along object boundaries, as described with reference to the model training and validation process 300 of FIG. 3. In aspects, the semantic segmentation may classify pixels into defect categories comprising at least scratch, dent, nick, and debris.

At block 1004, automated validation of the trained defect detection model against a validation set comprising known samples with annotated defects is performed. The validation set may comprise annotated real images and synthetic images, such as the validation set 226 described with reference to FIG. 2. The automated validation may comprise calculating alignment between model predictions and the annotated defects. The alignment calculation may employ validation metrics such as accuracy, intersection over union, precision, recall, or F1 score, as described with reference to step 308 of FIG. 3.

At decision 1006, a determination is made whether alignment between the model predictions and the annotated defects satisfies a threshold. The threshold may be a minimum accuracy percentage, a minimum intersection over union score, or a combination of metrics that must each satisfy respective thresholds. If the alignment satisfies the threshold, the example method 1000 proceeds to block 1008 where the model is validated and ready for deployment, such as deployment to the cosmetic inspection cell 102 or the server 108 described with reference to FIG. 1A.

At block 1010, responsive to determining that the alignment does not satisfy the threshold, misaligned devices from the validation set are identified and received. The received identification may categorize misalignments by defect type, device region, or surface material to focus subsequent improvement efforts.

At block 1012, a training dataset is improved based on the identified misaligned devices. The improving comprises at least one of receiving corrected annotations and adding new annotated samples. In aspects, improving the training dataset may comprise adding pixel-accurate annotations for defects larger than 5 by 5 pixels. The dataset improvement may address underrepresented defect categories or device configurations where the model showed weakness during validation.

At block 1014, the defect detection model is retrained using the improved training dataset. From block 1014, the example method 1000 may loop back to block 1004 for re-validation of the retrained model.

Having described an overview of some embodiments of the present technology, an example computing environment in which embodiments of the present technology may be implemented is described below in order to provide a general context for various aspects of the present technology. Referring now to FIG. 11 in particular, an example operating environment for implementing embodiments of the present technology is shown and designated generally as computing device 1100. Computing device 1100 is but one example of a suitable computing environment and is not intended to suggest any limitation as to the scope of use or functionality of the technology. Computing device 1100 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 11, computing device 1100 includes bus 1102, which directly or indirectly couples the following devices: memory 1104, one or more processors 1106, one or more presentation components 1108, input/output (I/O) ports 1110, input/output components 1112, and illustrative power supply 1114. Bus 1102 represents what may be one or more buses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 11 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 11 and with reference to “computing device.”

Computing device 1100 typically includes a variety of computer-readable media. Computer-readable media can be any available media that can be accessed by computing device 1100 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM (random access memory), ROM (read-only memory), EEPROM (electronically erasable programmable read-only memory), flash memory, or other memory technology; CD (compact disc)-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1100. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1104 includes computer storage media in the form of volatile or non-volatile memory. The memory may be removable, non-removable, or a combination thereof. Example hardware devices include solid-state memory, hard drives, optical-disc drives, etc. Computing device 1100 includes one or more processors that read data from various entities, such as memory 1104 or I/O components 1112. Presentation component(s) 1108 presents data indications to a user or other device. Example presentation components include a display device, speaker, printing component, vibrating component, etc. Processors 1106 may include one or more central processing units (CPUs), one or more graphics processing units (GPUs), neural processing units (NPUs), or other processing circuitry.

I/O ports 1110 allow computing device 1100 to be logically coupled to other devices, including I/O components 1112, some of which may be built-in. Illustrative components include a microphone, joystick, game pad, satellite dish, scanner, printer, wireless device, etc. The I/O components 1112 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1100. Computing device 1100 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1100 may be equipped with accelerometers or gyroscopes that enable detection of motion. The output of the accelerometers or gyroscopes may be provided to the display of computing device 1100 to render immersive augmented reality or virtual reality. Power supply 1114 may supply power to computing device 1100 or components thereof.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As further used herein, the term “train,” when referring to training a machine learning model, may mean training an untrained model, further training a previously trained model, fine-tuning a pre-trained model, or the like. “Train” is intended to broadly cover methods of machine learning using a dataset.

As used herein, terms of degree, such as “about,” “approximately,” “substantially,” or “generally,” are intended to encompass values within a reasonable range of the stated value, as would be understood by one of ordinary skill in the art in the context of the subject matter described. When used in connection with a numerical value, such as a number of pixels or other defined quantity, such terms of degree are intended to encompass a range of plus or minus ten percent of the stated value.

As used herein, a “scratch” may refer to a linear or curvilinear mark on a surface of a mobile device that may result from contact with another object. A scratch may be superficial, affecting only the outermost layer of the surface, or may extend deeper into the surface material. Scratches may vary in length, width, depth, and orientation, and may appear as single marks or as a pattern of multiple marks on the surface.

As used herein, a “dent” may refer to a localized depression or deformation in a surface of a mobile device. A dent may result from an impact or application of force to the surface. Dents may vary in size, depth, and shape, and may be visible as a change in the surface contour or as a variation in how light reflects from the affected area.

As used herein, a “nick” may refer to a small chip, notch, or indentation at or near an edge or surface of a mobile device. A nick may involve the removal or displacement of a small amount of surface material. In some cases, a nick may be distinguished from a dent by its relatively smaller size, its location near an edge or corner of the device, or the presence of material removal rather than surface deformation.

As used herein, “debris” may refer to foreign material present on a surface of a mobile device. Debris may include particles, residue, smudges, dust, fibers, adhesive remnants, or other contaminants that are not part of the original device surface. In some cases, debris may be visually similar in appearance to other defect types, such as scratches, and may be distinguished through analysis of characteristics such as shape, texture, or contrast relative to the surrounding surface.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the foregoing discussion include the following:

Aspect 1: A system for detecting cosmetic defects on mobile device surfaces, comprising: an imaging configured to capture images of a mobile device surface under one or more lighting conditions while the mobile device is positioned within an inspection cell that is part of an automated mobile device processing system; a lighting component configured to provide the one or more lighting conditions; a defect detection model comprising a convolutional neural network trained on a dataset comprising real images with segmentation masks and synthetic images generated using three-dimensional rendering; and a processor configured to: receive the captured images from the imaging device; apply the defect detection model to the captured images to generate a segmentation output identifying defect regions; and generate a composite image of the mobile device surface indicating detected defects.

Aspect 2: Aspect 1, wherein each lighting condition of the one or more lighting conditions is specific to a surface characteristic of the mobile device surface.

Aspect 3: Any of Aspects 1-2, wherein the segmentation output classifies pixels of the captured images into defect categories comprising at least scratch, dent, nick, and debris.

Aspect 4: Aspect 3, wherein the metadata associated with the detected defects comprises at least one of location, reflectivity, contrast ratio, depth of scratch, or surface type.

Aspect 5: Any of Aspects 1-4, wherein the convolutional neural network has an encoder-decoder architecture, the encoder configured to encode multi-scale contextual information, and the decoder configured to refine segmentation results along object boundaries.

Aspect 6: Aspect 5, wherein the decoder is configured to refine segmentation results by bilinearly upsampling encoder features and concatenating the upsampled features with low-level features from the encoder.

Aspect 7: Any of Aspects 1-6, wherein the dataset comprises real images that are downscaled and sliced into crops.

Aspect 8: Aspect 7, wherein the crops have a size of at least 400 by 400 pixels.

Aspect 9: Any of Aspects 1-8, wherein the synthetic images are generated using displacement maps and roughness maps.

Aspect 10: Any of Aspects 1-9, wherein the segmentation masks are pixel-accurate and are generated using manual annotation of defects larger than a threshold size.

Aspect 11: Aspect 10, wherein the threshold size at least 5 by 5 pixels.

Aspect 12: Any of Aspects 1-11, wherein the composite image comprises visual indications selectable to view metadata associated with the detected defects.

Aspect 13: Any of Aspects 1-12, wherein the one or more lighting conditions comprises at least two of simulated daylight, low light, diffuse light, directional light, polarized light, infrared light, or ultraviolet light.

Aspect 14: Any of Aspects 1-13, wherein the processor is further configured to assign a grade to the mobile device based on the detected defects, wherein the grade is determined at least in part by a location of a detected defect relative to a center of a display of the mobile device.

Aspect 15: Any of Aspects 1-14, wherein the defect detection model segments pixels into six classes with a pixel threshold of at least 0.75.

Aspect 16: Any of Aspects 1-15, wherein the one or more lighting conditions comprises a first lighting condition provided by a light source external to the mobile device and a second lighting condition provided by a light source integrated as part of the mobile device.

Aspect 17: A method for training a defect detection model for identifying cosmetic defects on mobile device surfaces, the method comprising: accessing a plurality of real images of mobile device surfaces captured by an imaging device under one or more lighting conditions; downscaling the plurality of real images by a scaling factor; slicing the downscaled real images into image crops of a predetermined size; receiving annotations for the image crops with segmentation masks identifying defect regions; generating synthetic images using a three-dimensional rendering application, the synthetic images comprising simulated defects with corresponding annotation maps; combining the annotated image crops and the synthetic images into a combined dataset; training the defect detection model using the combined dataset, wherein the defect detection model comprises a convolutional neural network with an encoder-decoder architecture configured to perform semantic segmentation of defects.

Aspect 18: Aspect 17, wherein the scaling factor is four or more.

Aspect 19: Any of Aspects 17-18, wherein slicing the downscaled real images into image crops comprises slicing with an overlap percentage between adjacent crops.

Aspect 20: Any of Aspects 17-19, wherein annotating the image crops comprises annotating defects larger than a threshold size or having contrast above a threshold contrast level.

Aspect 21: Aspect 20, wherein the threshold size is 5 by 5 pixels.

Aspect 22: Any of Aspects 17-21, wherein generating synthetic images using the three-dimensional rendering application comprises generating displacement maps and roughness maps for simulating surface defects.

Aspect 23: Aspect 22, wherein the synthetic images are combined with the annotated image crops using a synthetic augmentation algorithm.

Aspect 24: Any of Aspects 17-23, wherein training the defect detection model comprises using early stopping to prevent overfitting.

Aspect 25: Aspect 24, wherein training the defect detection model comprises segmenting pixels into six classes with a pixel threshold of 0.75, a learning rate of 0.0001, and no weight decay.

Aspect 26: Any of Aspects 17-25, further comprising: validating the trained defect detection model against the validation set to calculate alignment; identifying misaligned devices from the validation; and improving the dataset by correcting annotations or adding new samples based on the identified gaps.

Aspect 27: Any of Aspects 17-26, wherein the semantic segmentation of defects classifies pixels into defect categories comprising at least scratch, dent, nick, and debris.

Aspect 28: Any of Aspects 17-27, wherein the one or more lighting conditions comprises a first lighting condition provided by a light source external to the mobile device and a second lighting condition provided by a light source integrated as part of the mobile device.

Aspect 29: Any of Aspects 17-28, further comprising splitting the combined dataset into a training set, a test set, and a validation set, wherein training the defect detection model comprises training using the training set.

Aspect 30: A method, performed by one or more processors, for detecting cosmetic defects on a mobile device surface, the method comprising: receiving image data of a mobile device surface captured under one or more lighting conditions; applying a defect detection model to the image data, the defect detection model comprising a trained convolutional neural network having an encoder that encodes multi-scale contextual information and a decoder that refines segmentation results along object boundaries, wherein the defect detection model performs pixel-level classification to identify defect regions; and outputting a composite image of the mobile device surface indicating detected defect regions with visual indications of defect locations identified by the defect detection model.

Aspect 31: Aspect 30, wherein the encoder applies atrous spatial pyramid pooling to probe features at multiple rates and multiple effective fields-of-view.

Aspect 32: Aspect 31, wherein the decoder refines segmentation results by bilinearly upsampling encoder features by a factor of four and concatenating the upsampled features with low-level features from the encoder.

Aspect 33: Any of Aspects 30-32, wherein the one or more lighting conditions comprises at least two of simulated daylight, low light, diffuse light, directional light, polarized light, infrared light, or ultraviolet light.

Aspect 34: Any of Aspects 30-33, wherein the defect detection model is trained on a dataset comprising real images with pixel-accurate segmentation masks and synthetic images generated using three-dimensional rendering with displacement maps and roughness maps.

Aspect 35: Aspect 34, wherein the real images are sliced into image crops with an overlap between adjacent crops.

Aspect 36: Any of Aspects 30-35, further comprising assigning a grade to the mobile device based on the detected defects.

Aspect 37: Aspect 36, wherein the grade is determined at least in part by a location of a detected defect relative to a center of a display of the mobile device.

Aspect 38: Any of Aspects 30-37, wherein each lighting condition of the one or more lighting conditions corresponds to detection of a different defect characteristic.

Aspect 39: Any of Aspects 30-38, wherein the one or more lighting conditions comprises a first lighting condition provided by a light source external to the mobile device and a second lighting condition provided by a light source integrated as part of the mobile device.

Aspect 40: Any of Aspects 30-39, further comprising generating a segmentation output comprising classifications of the image data into defect categories, the defect categories comprising at least scratch, dent, nick, and debris.

Aspect 41: Any of Aspects 30-40, further comprising generating a probability heatmap indicating confidence levels for detected defects at each pixel location.

Aspect 42: One or more computer storage media storing instructions that, when executed by a processor, cause the processor to perform operations comprising: receiving image data of a mobile device surface captured by an imaging device under one or more lighting conditions; applying a defect detection model to the image data, the defect detection model comprising a convolutional neural network trained on a dataset comprising real images with segmentation masks and synthetic images, the defect detection model configured to perform semantic segmentation to classify pixels into defect categories; generating, using the defect detection model, a segmentation output identifying defect regions in the image data; and generating, based on the segmentation output, a composite image indicating the identified defect regions.

Aspect 43: Aspect 42, wherein the convolutional neural network comprises an encoder-decoder architecture, wherein the encoder encodes multi-scale contextual information by applying atrous convolution at multiple scales.

Aspect 44: Aspect 43, wherein the decoder refines segmentation results along object boundaries by bilinearly upsampling encoder features and concatenating the upsampled features with low-level features from the encoder.

Aspect 45: Any of Aspects 42-44, wherein the operations further comprise generating a probability heatmap indicating confidence levels for detected defects at each pixel location.

Aspect 46: Any of Aspects 42-45, wherein the defect categories comprise at least scratch, dent, nick, and debris.

Aspect 47: Any of Aspects 42-46, wherein the operations further comprise determining a grade for the mobile device based at least in part on the identified defect regions and locations of the identified defect regions on the mobile device surface.

Aspect 48: Any of Aspects 42-47, wherein the composite image includes metadata associated with the identified defect regions, the metadata comprising at least one of defect location, reflectivity, contrast ratio, depth of scratch, or defect type.

Aspect 49: A method performed by one or more processors for validating a defect detection model for cosmetic inspection of mobile devices, the method comprising: providing a trained defect detection model comprising a convolutional neural network with an encoder-decoder architecture configured to perform semantic segmentation of defect categories on mobile device surfaces; performing automated validation of the trained defect detection model against a validation set comprising known samples with annotated defects, the validation set comprising annotated real images and synthetic images, the automated validation comprising calculating alignment between model predictions and the annotated defects; determining whether alignment between the model predictions and the annotated defects satisfies a threshold; responsive to determining that the alignment does not satisfy the threshold, identifying misaligned devices from the validation set; improving a training dataset based on the identified misaligned devices, the improving comprising at least one of receiving corrected annotations and adding new annotated samples; and retraining the defect detection model using the improved training dataset.

Aspect 50: Aspect 49, wherein the semantic segmentation classifies pixels into defect categories comprising at least scratch, dent, nick, and debris.

Aspect 51: Any of Aspects 49-50, wherein improving the training dataset comprises adding pixel-accurate annotations for defects larger than 5 by 5 pixels.

Aspect 52: A cosmetic inspection cell for an automated mobile device processing system, the cosmetic inspection cell comprising: an imaging device and a plurality of lighting components aligned along a movement path of a mobile device, the plurality of lighting components configured to provide one or more lighting conditions as the mobile device moves through the cosmetic inspection cell, wherein the imaging device is configured to capture images of the mobile device under the one or more lighting conditions; and a communication interface configured to transmit the captured images to a defect detection system comprising a convolutional neural network having an encoder-decoder architecture, the encoder configured to encode multi-scale contextual information, and the decoder configured to refine segmentation results along object boundaries, and to receive, from the defect detection system, defect detection results comprising identified defect regions based on pixel-level classification of the captured images.

Aspect 53: Aspect 52, wherein the convolutional neural network is trained on a dataset comprising real images with segmentation masks.

Aspect 54: Aspect 53, wherein the convolutional neural network is further trained using synthetic images generated using three-dimensional rendering with displacement maps and roughness maps.

Aspect 55: Aspect 54, wherein the real images in the dataset are downscaled by a scaling factor of four and sliced into image crops of approximately 400 by 400 pixels with an overlap percentage between adjacent crops, and wherein the pixel-accurate segmentation masks are generated using manual annotation of defects larger than 5 by 5 pixels.

Aspect 56: Any of Aspects 52-55, wherein the defect detection results further comprise metadata associated with the identified defect regions, the metadata comprising at least one of defect location, reflectivity, contrast ratio, depth of scratch, or surface type.

What is claimed is:

1. A system for detecting cosmetic defects on a mobile device surface, comprising:
an imaging configured to capture images of a mobile device surface under one or more lighting conditions while the mobile device is positioned within an inspection cell that is part of an automated mobile device processing system;
a lighting component configured to provide the one or more lighting conditions;
a defect detection model comprising a convolutional neural network trained on a dataset comprising real images with segmentation masks and synthetic images generated using three-dimensional rendering; and
a processor configured to execute instructions store in computer storage media to:
receive the captured images from the imaging device;
apply the defect detection model to the captured images to generate a segmentation output identifying defect regions; and
generate a composite image of the mobile device surface indicating detected defects.

2. The system of claim 1, wherein the segmentation output classifies pixels of the captured images into defect categories comprising at least scratch, dent, nick, and debris.

3. The system of claim 1, wherein the convolutional neural network has an encoder-decoder architecture, the encoder configured to encode multi-scale contextual information, and the decoder configured to refine segmentation results along object boundaries.

4. The system of claim 1, wherein the segmentation masks are pixel-accurate and are generated using manual annotation of defects larger than a threshold size.

5. The system of claim 1, wherein the composite image comprises visual indications selectable to view metadata associated with the detected defects.

6. The system of claim 1, wherein the one or more lighting conditions comprises at least two of simulated daylight, low light, diffuse light, directional light, polarized light, infrared light, or ultraviolet light.

7. The system of claim 1, wherein the processor is further configured to assign a grade to the mobile device based on the detected defects, wherein the grade is determined at least in part by a location of a detected defect relative to a center of a display of the mobile device.

8. The system of claim 1, wherein the one or more lighting conditions comprises a first lighting condition provided by a light source external to the mobile device and a second lighting condition provided by a light source integrated as part of the mobile device.

9. A method for training a defect detection model for identifying cosmetic defects on mobile device surfaces, the method comprising:
accessing a plurality of real images of mobile device surfaces captured by an imaging device under one or more lighting conditions;
downscaling the plurality of real images by a scaling factor;
slicing the downscaled real images into image crops of a predetermined size;
receiving annotation for the image crops with segmentation masks identifying defect regions;
generating synthetic images using a three-dimensional rendering application, the synthetic images comprising simulated defects with corresponding annotation maps;
combining the annotated image crops and the synthetic images into a combined dataset; and
training the defect detection model using the combined dataset, wherein the defect detection model comprises a convolutional neural network with an encoder-decoder architecture configured to perform semantic segmentation of defects.

10. The method of claim 9, wherein the scaling factor is four or more.

11. The method of claim 9, wherein slicing the downscaled real images into image crops comprises slicing with an overlap percentage between adjacent crops.

12. The method of claim 9, wherein annotating the image crops comprises annotating defects larger than a threshold size or having contrast above a threshold contrast level.

13. The method of claim 12, wherein the threshold size is at least 5 by 5 pixels.

14. The method of claim 9, wherein the semantic segmentation of defects classifies pixels into defect categories comprising at least scratch, dent, nick, and debris.

15. A method, performed by one or more processors, for detecting cosmetic defects on a mobile device surface, the method comprising:
receiving image data of a mobile device surface captured under one or more lighting conditions;
applying a defect detection model to the image data, the defect detection model comprising a trained convolutional neural network having an encoder that encodes multi-scale contextual information and a decoder that refines segmentation results along object boundaries, wherein the defect detection model performs pixel-level classification to identify defect regions; and
outputting a composite image of the mobile device surface indicating detected defect regions with visual indications of defect locations identified by the defect detection model.

16. The method of claim 15, wherein the one or more lighting conditions comprises at least two of simulated daylight, low light, diffuse light, directional light, polarized light, infrared light, or ultraviolet light.

17. The method of claim 15, wherein the defect detection model is trained on a dataset comprising real images with pixel-accurate segmentation masks and synthetic images generated using three-dimensional rendering with displacement maps and roughness maps.

18. The method of claim 15, further comprising assigning a grade to the mobile device based on the detected defects.

19. The method of claim 18, wherein the grade is determined at least in part by a location of a detected defect relative to a center of a display of the mobile device.

20. The method of claim 18, wherein the one or more lighting conditions comprises a first lighting condition provided by a light source external to the mobile device and a second lighting condition provided by a light source integrated as part of the mobile device.
